(19) United States
(12) Patent Application Publication
(10) Pub. No.: US 2005/0215730 A1
(43) Pub. Date: Sep. 29, 2005

(54) Polycarboxy-functionalized prepolymers

(76) Inventor: Rainer Schoenfeld, New Berlin, WI (US)

Correspondence Address: HENKEL CORPORATION, THE TRIAD, SUITE 200, 2200 RENAISSANCE BLVD., GULPH MILLS, PA, 19406, US

(21) Appl. No.: 10/808,992

(22) Filed: Mar. 24, 2004

(51) Int. Cl. C08G 59/16

(52) U.S. Cl. 525/533

(57) ABSTRACT

Products prepared from polycarboxylic anhydrides and active hydrogen-functionalized elastomeric polymers, in particular polyoxyalkyleneamines, are suitable as builder components (prepolymers) for epoxy resin compositions. The reaction products are distinguished by having a plurality of carboxyl groups, but no imide groups, in each molecule. The reaction products may optionally be further reacted with epoxy resins and may optionally be formulated together with polymers having at least one glass transition temperature of −30° C. or lower and epoxy-reactive groups and/or reaction products of said polymers with epoxy resins to provide resin systems useful in adhesives. Such adhesive formulations may additionally contain liquid and/or solid epoxy resins and/or hardeners and/or accelerators and/or fillers and/or and/or other impact-modifying components and/or rheology auxiliaries. Such compositions exhibit excellent shelf life and are particularly suitable as impact-resistant and peel-resistant adhesives in vehicle construction and in electronics. Particularly at very low temperatures, these adhesives exhibit very good impact and peel properties combined with very good corrosion resistance and aging resistance of the adhesive bond.

### FIELD OF THE INVENTION

This invention relates to certain polycarboxy-functionalized prepolymers and mixtures and/or adducts of these prepolymers with epoxy resins and/or certain epoxy group-reactive polymers having at least one glass transition temperature of −30° C. or epoxy resin adducts thereof. The polycarboxy-functionalized prepolymers and the aforementioned mixtures and adducts may be combined with thermally activatable latent hardeners, accelerators, fillers, thixotropic auxiliaries and/or further additives to provide reactive adhesives. The present invention also relates to a process for the production of such compositions and to the use thereof as reactive adhesives.

### DISCUSSION OF THE RELATED ART

Reactive, hot-melt epoxy-based adhesives are known. In machinery and vehicle or equipment construction, in particular in aircraft construction, railway vehicle construction or motor vehicle construction, assemblies of various metallic components and/or composite materials are increasingly being joined together with adhesives. Epoxy adhesives are widely used for structural bonds requiring high levels of strength, in particular as thermosetting, single component adhesives, which are frequently also formulated as hot-melt adhesives. Reactive hot-melt adhesives are adhesives which are solid at room temperature and soften at temperatures of up to about 80 to 90° C. and behave like a thermoplastic material. It is only at higher temperatures (i.e., greater than about 100° C.) that the latent hardeners present in these hot-melt adhesives are thermally activated, resulting in irreversible curing to yield a thermoset material. In order to join components, for example in the vehicle construction industry, the adhesive is initially applied hot on at least one substrate surface and the components to be bonded are then joined. On cooling, the adhesive then solidifies and, by this physical solidification, creates a bond which is sufficiently strong for handling, that is a temporary bond. The components bonded in this manner are further processed in the various rinsing, phosphating and dipcoating baths and the adhesive is only subsequently cured in an oven at relatively high temperatures.

Conventional adhesives and hot-melt adhesives based on epoxy resins are hard and brittle when in the cured state. The adhesive bonds obtained do indeed generally exhibit very high tensile shear strength, but, on exposure to peel, impact or impact/peel stress, particularly at low temperatures, they flake, such that this type of stress readily causes the adhesive joint to fail. Numerous proposals have accordingly already been made to modify epoxy resins using flexible additions in such a manner that the brittleness thereof is reduced significantly. One common method is based on the use of certain rubber adducts on epoxy resins, which are incorporated into the epoxy resin matrix as a heterodisperse phase, such that the epoxides become more impact-resistant. Such epoxy resin compositions are described as being “toughened”. One common modification of epoxy resins of the above type involves reacting a polybutadiene-co-acrylonitrile copolymer having carboxyl end groups with an epoxy resin. This rubber/epoxy adduct is then dispersed in one or more different epoxy resins. In this method, the reaction of the epoxy resin with the butadiene/acrylonitrile rubber containing carboxyl groups must be controlled in such a manner that it does not result in premature curing of the adduct. Although epoxy resin compositions modified in this manner do constitute a distinct improvement with regard to the impact strength thereof in comparison with unmodified epoxy resins, the performance thereof on exposure to peel or impact/peel stress is still inadequate.

One proposed approach to solving such problems is described in U.S. Published Application No. 2003/0187154. This application discloses impact-resistant epoxy resin compositions containing condensation products prepared from cyclic carboxylic anhydrides of di-, tri, or tetracarboxylic acids and difunctional polyamines. The reaction products based on tricarboxylic anhydrides or tetracarboxylic anhydrides are distinguished by having on average more than one imide group and carboxyl group per molecule. The impact-resistant epoxy resin compositions may alternatively or additionally contain condensation products obtained from tri- or poly-functional polyols and/or tri- or poly-functional amino-terminated polymers and cyclic carboxylic anhydrides, wherein the condensation products contain on average more than one carboxyl group per molecule.

Although these adhesive compositions overall already have a very good range of properties even at low temperatures, the development of other adhesives having further property improvements would be desirable.

An object of the present invention is to improve further reactive adhesives of the above type such that they exhibit improved shelf life, better storage stability, adequate flexibility, increased peel strength not only at room temperature but also in particular at low temperatures of below 0° C. In particular, peel strength should be as high as possible at operating temperatures on exposure to impact stress, so that structurally bonded components meet modern safety requirements in automotive construction even in the event of an accident (crash behavior). These improvements should be achieved without impairment of either peel strength or tensile shear strength at elevated temperatures. The reactive adhesives must, moreover, have adequate rinse resistance immediately after application and before final curing. To this end, it must be possible to formulate the adhesive compositions as a hot-melt adhesive (i.e., as a highly viscous, hot-processed adhesive). Another possibility is to formulate it as an adhesive which may be gelled by a thermal pre-reaction in a “carcass oven” or by induction heating of the parts to be joined.

### SUMMARY OF THE INVENTION

The present invention provides a thermally curable composition comprising at least one polycarboxy-functionalized prepolymer having the structure R¹[—X—C(═O)-Cy(CO₂H)_{q}]ₙ[—X—C(═O)—R³—CO₂H]ₚ[X—H]ₘ₋₍ₙ₊ₚ₎, or at least one reaction product of said polycarboxy-functionalized prepolymer with at least one epoxy resin, or a mixture thereof, wherein R¹ is the m-valent radical of an elastomeric polymer, X is —O—, —S—, or —NR²— (preferably —NH—), Cy is an aromatic or aliphatic ring, R² is H or a C₁-C₆ alkyl group, R³ is a radical containing at least one carbon-carbon double bond, m is an integer from 2 to 6, n is an integer from 1 to 6, p is 0 or an integer from 1 to 5, m is greater than or equal to n+p, and q is an integer of at least 2 (preferably, 2 or 3).

Such compositions may be additionally comprised of polymers having at least one glass transition temperature of −30° C. or lower and epoxy-reactive groups, reaction products of said polymers with epoxy resins, thermally activatable latent hardeners, epoxy resins, unsaturated carboxy-functionalized prepolymers, adducts of unsaturated carboxy-functionalized prepolymers and epoxy resins, fillers, thixotropic agents, accelerators, and/or epoxy resins. The compositions of the present invention are useful as components of impact resistant epoxy resin formulations for use as thermosettable structural adhesives and the like.

### DETAILED DESCRIPTION OF CERTAIN EMBODIMENTS OF THE INVENTION

As will be described in more detail subsequently, the polycarboxy-functionalized prepolymer is preferably produced by reacting an acid anhydride containing at least one anhydride group and at least one free carboxylic acid group and amino-terminated, sulfide (—SH)-terminated or hydroxy-terminated polymers. The reaction is carried out under conditions effective to avoid formation of an imide group, where one of the starting materials is an amino-terminated polymer. These reaction products may then be reacted with an epoxy resin such as a polyglycidyl ether of a bisphenol (a particularly preferred embodiment of the invention, since such reaction tends to improve the stability of the composition) or may simply be mixed with such epoxy resins together with a thermally activatable hardener and/or further additives to provide a thermosettable formulation capable of being used, for example, as a structural adhesive.

The compositions of the present invention may comprise one or more substances having the structure R¹[—X—C(═O)-Cy(CO₂H)_{q}]ₙ[—X—C(═O)—R³—CO₂H]ₚ[X—H]ₘ₋₍ₙ₊ₚ₎ and/or reaction products of such substances with epoxy resins, wherein R¹ is the m-valent radical of an elastomeric polymer, R³ is a radical containing at least one carbon-carbon double bond, X is —O—, —S—, or —NR²—, Cy is an aromatic or aliphatic ring, R² is H or a C₁-C₆ alkyl group, m is an integer from 2 to 6, n is an integer from 1 to 6, p is 0 or an integer from 1 to 5, m is greater than or equal to n+p, and q is an integer of at least 2 (preferably 2 or 3). In preferred embodiments of the invention, X is —NH—. Preferably, m is 2 or 3. The elastomeric polymer is preferably a polyoxyalkylene ether, particularly a polyoxypropylene ether. Preferably, the elastomeric polymer is soluble or dispersible in epoxy resins. Cy may be a single aromatic ring (such as benzene), a fused aromatic ring (such as naphthalene), or connected aromatic rings (such as diphenylmethane, benzophenone, or biphenyl). The aromatic or aliphatic ring(s) of Cy may be substituted with alkyl groups (e.g., methyl), halogens (e.g., Cl), or other substituents in addition to carboxy groups. In preferred embodiments of the invention, R³ is a —CR⁴═CR⁵— group, wherein R⁴ and R⁵ are the same or different and are selected from H, C₁-C₆ alkyl, or aryl. Preferably, R⁴ and R⁵ are both H. The polycarboxy-functionalized prepolymers used in the present invention are characterized by the absence of imide groups. In certain embodiments of the invention, at least one —CO₂H group attached to Cy is attached such that two carbon atoms separate said group from the —C(═O)— group also attached to the Cy moiety.

Such polycarboxy-functionalized prepolymers may be conveniently prepared by reacting an active hydrogen-functionalized elastomeric polymer with a polycarboxylic compound containing at least three carboxy groups (e.g., trimellitic anhydride) under conditions effective to avoid imide formation. In one embodiment of the invention, the polycarboxy-functionalized prepolymer is prepared by reacting an active hydrogen-functionalized elastomeric polymer with both a polycarboxylic compound containing at least three carboxy groups and an unsaturated dicarboxylic compound (e.g., maleic anhydride) under conditions effective to avoid imide formation.

The active hydrogen-functionalized elastomeric polymers used to prepare the polycarboxy-functionalized prepolymer may preferably be amino-terminated polyalkylene glycols, in particular di- and trifunctional amino-terminated polypropylene glycols, polyethylene glycols or copolymers obtained by copolymerization (simultaneous or sequential) of ethylene oxide and propylene oxide followed by conversion of the terminal —OH groups to amino groups. Such materials are sold under the trade name “Jeffamine” by the Huntsman Chemical Company. Polyfunctional amino-terminated polyoxytetra-methylene glycols, also known as poly-THF, are also suitable. Polyfunctional amino-terminated polybutadiene compounds are moreover suitable as starting materials, as are aminobenzoic acid esters of polypropylene glycols, polyethylene glycols or poly-THF (sold under the trade name “Versalink oligomeric diamines” by Air Products). The amino-terminated polyalkylene glycols or polybutadienes preferably have number average molecular weights of between 400 and 6000. The terminal amino groups are preferably primary amino groups (—NH₂).

Preferably, the polycarboxylic compound reacted with the active hydrogen-functionalized elastomeric polymer contains a single anhydride group (i.e., two of the carboxy groups are linked to form an anhydride) and the other carboxy group(s) are present in the free carboxylic acid form (—CO₂H). Carboxylic acid esters groups (—CO₂R, where R is alkyl or aryl) and/or carboxylic acid amide groups (—C(═O)NR₂, where R is H, alkyl or aryl) may also be present. Alternatively, however, the polycarboxylic compound can contain two anhydride groups. In this embodiment, the active hydrogen-functionalized elastomeric polymer is reacted under conditions such that generally only one anhydride group per molecule reacts. The second anhydride group may then be reacted with any suitable nucleophile to provide a second free carboxylic acid group. For example, a monomeric monoalcohol or monoamine may be used as the nucleophile. The polycarboxylic compound may alternatively contain a single anhydride group and the other carboxy group(s) are present in amide or ester form. Other approaches to synthesizing the polycarboxy-functionalized prepolymers used in the present invention will be readily apparent to those skilled in the art.

Examples of aromatic tri- or tetra-carboxylic compounds suitable for use include 1,2,3- and 1,2,4-benzenetricarboxylic anhydride, mellophanic anhydride, pyromellitic mono- and dianhydride, monoesters and monoamides of pyromellitic anhydride, 1,8:4,5- and 2,3:6,7-naphthalenetetracarboxylic mono- and dianhydride, perylene mono- and dianhydride, biphenyltetracarboxylic mono- and di-anhydride, diphenyl ether tetracarboxylic mono- and dianhydride, diphenylmethanetetracarboxylic mono- and dianhydride, 2,2-diphenylpropanetetracarboxylic mono- and dianhydride, benzophenonetetracarboxylic mono- and dianhydride, diphenyl sulfone tetracarboxylic mono- and dianhydride and mixtures thereof.

As mentioned previously, the active hydrogen-functionalized elastomeric polymer may be reacted with both a polycarboxylic compound and an unsaturated dicarboxylic compound. Such reaction yields a polycarboxy-functionalized prepolymer having a value of p of 1 or more. Suitable unsaturated dicarboxylic compounds contain at least one carbon-carbon double bond and are preferably unsaturated cyclic anhydrides, although the carboxylic acid groups could alternatively be in the free acid or ester form. Illustrative unsaturated dicarboxylic compounds include maleic anhydride, citraconic anhydride, itaconic anhydride, phenyl maleic anhydride, dimethyl maleic anhydride, and mixtures thereof. In preferred embodiments of the invention, R³ in the previously described structural formula of the polycarboxy-functionalized prepolymer is a —CR⁴═CR⁵— group, wherein R⁴ and R⁵ are the same or different and are selected from H, C₁-C₆ alkyl, or aryl. Preferably, R⁴ and R⁵ are both H.

The reaction between the elastomeric polymer containing primary amino (—NH₂) and the polycarboxylic compound (and, optionally, unsaturated dicarboxylic compound) must be controlled such that open-chain amide structures having at least one free carboxyl group but no imide groups are obtained. Although such conditions will vary depending upon the reactants selected and the presence or absence of any catalysts, typically imide formation can be avoided by carrying out the reaction between an anhydride-containing polycarboxylic compound and an amino-functionalized elastomeric polymer at a temperature not greater than 100 degrees C. Generally speaking, reaction temperatures of from about 50 degrees C. to about 85 degrees C. have been found to be effective.

Suitable epoxy resins for forming the epoxy adduct of the polycarboxy-functionalized prepolymer or for blending with such prepolymers comprise numerous polyepoxides having at least two 1,2-epoxy groups per molecule. The epoxy equivalent weight of these epoxy resins may preferably range between 150 and 4000. The epoxy resins may, in principle, be saturated, unsaturated, cyclic or acyclic, aliphatic, alicyclic, aromatic or heterocyclic polyepoxy compounds. Examples of suitable epoxy resins include the polyglycidyl ethers obtained by reacting epichlorohydrin or epibromohydrin with a polyphenol in the presence of alkali. Polyphenols suitable for this purpose are, for example, resorcinol, pyrocatechol, hydroquinone, bisphenol A (bis(4-hydroxyphenyl)-2,2-propane)), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, and 1,5-hydroxynaphthalene. Bisphenol A and bisphenol F are especially preferred polyphenols.

Further epoxy resins which are suitable in principle are the polyglycidyl ethers of polyalcohols or diamines. These polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Further suitable epoxy resins are polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or dimer fatty acid.

Further suitable epoxy resins are derived from the epoxidation products of olefinically unsaturated cycloaliphatic compounds or from natural oils and fats.

Epoxy resins derived from the reaction of bisphenol A or bisphenol F and epichlorohydrin are particularly preferred. Mixtures of liquid and solid epoxy resins of this type may be used. Epoxy resins liquid at room temperature which have an epoxy equivalent weight of 150 to about 220 are generally preferred.

Any of the aforementioned epoxy resins may be used as additional components of the curable compositions of the present invention. That is, instead of being prereacted with the polycarboxy-functionalized prepolymer, such epoxy resins may be simply blended or combined with the prepolymer prior to curing. Mixtures of epoxy resin/polycarboxy-functionalized prepolymer adducts and epoxy resins may also be employed.

Examples of the polymers useful as supplemental or additional components in the curable compositions of the present invention are 1,3-diene polymers having carboxyl groups and further polar, ethylenically unsaturated comonomers. Butadiene, isoprene or chloroprene may here be used as the diene, with butadiene being preferred. Examples of polar, ethylenically unsaturated comonomers are acrylic acid, methacrylic acid, lower alkyl esters of acrylic or methacrylic acid, for example the methyl or ethyl esters thereof, amides of acrylic or methacrylic acid, fumaric acid, itaconic acid, maleic acid or the lower alkyl esters or semi-esters thereof, or maleic or itaconic anhydride, vinyl esters, such as vinyl acetate or in particular acrylonitrile or methacrylonitrile. Particularly preferred polymers include carboxy-terminated butadiene/acrylonitrile copolymers (CTBN), which are commercially available in liquid form under the trade name HYCAR by B.F. Goodrich. These have molecular weights of between 2000 and 5000 and acrylonitrile contents of between 10 and 30%. Specific examples are HYCAR CTBN 1300×8, 1300×13 and 1300×15. In one embodiment of the invention, about 20 to about 60 weight percent carboxy-terminated butadiene/acrylonitrile copolymer is reacted with about 40 to about 80 weight percent of an epoxy resin (preferably a liquid polyglycidyl ether of a bisphenol such as bisphenol A) to provide an adduct useful as an optional component of the compositions of the present invention. Typical reaction conditions for preparing such adducts include heating the reactants at a temperature of from about 70 degrees C. to about 160 degrees C. for 1 to 10 hours, preferably in the presence of a catalyst such as a phosphine.

The core/shell polymers known from U.S. Pat. No. 5,290,857 or from U.S. Pat. No. 5,686,509 may also be used as optional additional components of the compositions of the present invention. In this case, the core monomers should have a glass transition temperature of less than or equal to −30° C.; these monomers may be selected from the group consisting of the above-mentioned diene monomers or suitable acrylate or methacrylate monomers, and the core polymer may optionally contain a small quantity of crosslinking comonomer units. The shell is built up from a copolymer which has a glass transition temperature of at least 60° C. The shell is preferably prepared from lower alkyl acrylate or methacrylate monomer units (methyl or ethyl ester), together with polar monomers, such as (meth)acrylonitrile, (meth)acrylamide, styrene or free-radically polymerizable unsaturated carboxylic acids or carboxylic anhydrides.

Another possibility for the polymer is to use hyperbranched polymers, which are also known as dendrimers, dendritic polymers, cascade polymers or “starburst” polymers. As is known, they are built up in a step-wise manner by linking two or more monomers with each monomer already bonded, such that the number of monomer end groups grows exponentially with each step, ultimately resulting in a spherical tree-like structure. Such hyperbranched polymers are known, for example, from U.S. Pat. Nos. 5,663,247, 5,990,260, 6,093,777, and 6,211,329 (each of which is incorporated herein by reference in its entirety) may, for example, be produced by Michael addition of acrylic acid methyl esters and ammonia or amines. Hyperbranched polymers containing polyester units are particularly preferred.

The adducts of epoxy resins and the above-mentioned liquid CTBN rubbers are, however, particularly preferred for use.

Reaction products (adducts) of polymers having at least one glass transition temperature of −30° C. or lower and epoxy-reactive groups with epoxy resins suitable for use in the present invention may be obtained from commercial sources. For example, the elastomer-modified epoxy prepolymers sold under the tradename “Polydis” by the Struktol Company of America may be utilized.

The curable compositions of the present invention may additionally include any of the adducts and/or prepolymers and or other components known in the art of impact-modified epoxy resin systems, including, for example, the materials described in WO 03/055957, U.S. Published Application No. 2003/0187154, U.S. Pat. No. 5,202,390, WO 00/37554, U.S. Pat. No. 5,030,698, U.S. Pat. No. 5,278,257, U.S. Pat. No. 5,006,611, U.S. Pat. No. 4,952,645, CA 1,334,700, the disclosure of each being incorporated herein by reference in its entirety.

Thermally activatable or latent hardeners which may be used in the curable compositions of the present invention include guanidines, substituted guanidines, substituted ureas, melamine resins, guanamine derivatives, cyclic tertiary amines, aromatic amines and/or mixtures thereof. The hardeners may either participate stoichiometrically in the curing reaction or they may also or alternatively be catalytically active. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and very particularly cyanoguanidine (dicyandiamide). Examples of suitable guanamine derivatives which may be mentioned are alkylated benzoguanamine resins, benzoguanamine resins or methoxymethylethoxymethylbenzoguanamine. The selection criterion for hardeners to be used in single component, thermosetting hot-melt adhesives is, of course, the low solubility of these substances in the resin system at room temperature, such that solid, finely ground hardeners are preferred for this use, with dicyandiamide in particular being suitable. This ensures good storage stability of the composition.

Catalytically active substituted ureas may be used in addition to or instead of the above-mentioned hardeners. Such ureas in particular comprise p-chlorophenyl-N,N-dimethylurea (Monuron), 3-phenyl-1,1-dimethylurea (Fenuron) or 3,4-dichlorophenyl-N,N-dimethylurea (Diuron). Catalytically active aryl- or alkyl-amines, such as benzyldimethylamine, tris(dimethylamino)phenol, piperidine or piperidine derivatives, may in principle also be used, but many of these are too highly soluble in the resin system, such that the storage stability of the single component system is inadequate for practical purposes. Various preferably solid imidazole derivatives may furthermore be used as catalytically active accelerators. Examples which may be mentioned are 2-ethyl-2-methylimidazole, N-butylimidazole, benzimidazole and N—C₁-C₁₂ alkylimidazoles or N-arylimidazoles.

The adhesives according to the present invention generally also contain known fillers, such as the various ground or precipitated chalks, carbon black, calcium/magnesium carbonates, barytes, as well as silicate fillers of the aluminum/magnesium/calcium silicate type, for example wollastonite and chlorite.

The compositions according to the present invention may also contain further auxiliary substances and additives of the type conventionally used in adhesives, such as plasticizers, extenders, reactive diluents, reinforcing agents, foaming (blowing) agents (including physical as well as chemical foaming agents, particularly latent foaming agents activated by heating), flame retardants, mold release agents, rheology auxiliaries (thixotropic agents) such as silica, wetting agents, antioxidants, stabilizers and/or colored pigments.

The compositions according to the present invention may, on the one hand, be formulated as single component adhesives, wherein these may be formulated both as relatively low viscosity, room temperature-applicable adhesives and as highly viscous thermally curable hot-melt adhesives. These adhesives may also be formulated as single component pre-gellable adhesives, in which case the compositions contain either finely divided thermoplastic powders, such as polymethacrylates, polyvinyl butyral or other thermoplastic (co)polymers or the curing system is tailored such that the curing process proceeds in two-stages, wherein the gelation step brings about only partial curing of the adhesive and, in automotive construction, final curing occurs, for example, in a lacquering oven, preferably in a cathodic dipcoating oven.

The compositions according to the present invention may also be formulated as two-component epoxy adhesives, in which the two reaction components are mixed together only shortly before application, wherein curing then proceeds at room temperature or at moderately elevated temperature. The reaction components known for two-component epoxy adhesives, for example di- or poly-amines, amino-terminated polyalkylene glycols or polyaminoamides, may here be used as the second reaction component. Further reactive components may comprise mercapto-functional prepolymers. The compositions according to the present invention may, in principle, also be cured with carboxylic anhydrides as the second reaction component in two-component adhesive formulations.

In addition to the above-stated applications, the adhesive compositions according to the present invention may also be used as casting resins in the electrical or electronics industry or as die attach adhesives in electronics for bonding components to printed circuit boards. Further possible applications for the compositions according to the present invention are as matrix materials for composite materials, such as fiber-reinforced composites.

Further preferred applications for the adhesive compositions according to the present invention both in the single component, heat-curable form and in the two-component comprise the use thereof as a structural foam, for example for providing internal stiffening in cavities in vehicle construction, wherein the expanded structural foams provide stiffening in the cavities of the vehicle or increase the energy absorption capacity. The compositions may also be used for producing “stiffening pads” or for stiffening coatings for thin sheet metal or plastics components, preferably in vehicle construction. The adhesive compositions thus may include latent blowing agents, which are activated when the composition is heated and cause the composition to foam or expand due to the evolution of gas. Suitable latent blowing agents include both chemical and physical blowing agents.

One particularly preferred application for the adhesives according to the present invention is, however, for structural bonds in vehicle construction.

Depending upon the requirements desired for the composition with respect to its processing characteristics, flexibility, impact/peel strength or tensile strength, the quantity ratios of the individual components may vary within relatively broad limits. Typical ranges for the components are:
Polycarboxy-functionalized prepolymer(s) and/or polycarboxy-functionalized prepolymer/epoxy resin adduct(s): preferably 5-60 wt. %, more preferably 10-45 wt. %;
Polymer(s) having at least one glass transition temperature of −30° C. or lower and epoxy-reactive groups and/or reaction products of said polymers with epoxy resins: preferably 0-40 wt. %, more preferably 10-30 wt. %;
Latent hardener(s) (for thermally curable single component systems): preferably 1-10 wt. %, more preferably 3-8 wt. %;
Epoxy resin(s) (in addition to the epoxy resin(s) present in adducted form): preferably 0-70 wt. %, more preferably 10-60 wt. %;
Filler(s): preferably 0-40 wt. %, more preferably 0.5-20 wt. %;
Accelerator(s): preferably 0 to 3 wt. %, more preferably 0.1 to 0.8 wt. %;
Rheology auxiliary(ies) (thixotropic agent(s)): preferably 0-10 wt. %, more preferably 0.5-6 wt. %;
   wherein the sum of the constituents is 100%.

In certain embodiments of the invention, the total amount of epoxy resin in the composition (that is, the weight of epoxy resin in the form of an adduct with the polycarboxy-functionalized prepolymer plus the weight of epoxy resin which is not in the form of such an adduct) is from 30-60 wt. % or more preferably from 35-55 wt. %.

As mentioned above, the requirements placed upon modern structural adhesives in vehicle construction are constantly increasing as ever more assemblies, including load-bearing assemblies, are joined by adhesive bonding methods. As has already been explained in the paper by G. Kötting and S. Singh, “Anforderungen an Klebstoffe für Strukturverbindungen im Karosseriebau” [=Requirements of Adhesives for Structural Vehicle Body Construction], Adhesion 1988, issue 9, pages 19 to 26, the adhesives must firstly meet practical production requirements, such as automatable processing using short cycle times, adhesion to oiled metal sheets, adhesion to various types of metal sheets and compatibility with the processing conditions prevailing in the coating line (resistance to rinsing and phosphating baths, curable during stoving of cathodic dipcoated primer, resistance to subsequent painting and drying operations). Modern structural adhesives must furthermore also meet rising strength and deformation properties in the cured state. Such properties include the increased corrosion resistance and flexural rigidity of structural components, as well as deformability on exposure of the adhesive bond mechanical stress. The highest possible component deformability provides a considerable safety advantage on exposure to impact stress in an accident (crash behavior). This behavior may best be monitored by determining the impact energy for cured adhesive bonds, with sufficiently high impact energy or impact/peel energy being desirable or necessary both at elevated temperatures of up to +90° C. and in particular also at low temperatures of down to −40° C. The highest possible tensile shear strength should simultaneously also be achieved. Both types of strength must be achieved on numerous substrates, primarily oiled metal sheets, such as bodywork sheet steel, sheet steel galvanized by various methods, sheets of various aluminum alloys or also magnesium alloys and coil-coated sheet steel provided with organic coatings (such as those marketed under the trade names “Bonazinc” and “Granocoat”). The adhesive compositions according to the present invention surprisingly to a very great extent meet these requirements.

The following Examples are intended to illustrate the invention in greater detail. Unless otherwise indicated, all quantities in the compositions are stated in parts by weight.

### EXAMPLES

General Production Method for Component (A)

Two parts by weight of a carboxy-terminated poly(butadiene-co-acrylonitrile) (HYCAR CTBN 1300×13) were reacted with stirring at 140° C. with three parts of a liquid DGEBA (bisphenol A diglycidyl ether) epoxy resin and 0.01-1 ppm triphenylphosphine for 5 hours until constancy of the reaction was achieved.

General Production Method for Component (B)

1 mol of the carboxylic anhydrides were reacted with stirring at 75-110° C. for 3 to 5 hours with 0.8 to 1.4 eq of a difunctional or trifunctional amino-terminated polyalkylene glycol. The reaction product is optionally reacted at 80-110° C. for 45-120 minutes with 1 to 2 times its mass of an epoxy resin and 0.01 to 0.2 wt. % of triphenyl phosphine.

General Production Method for Component (C)

1 mol of the carboxylic anhydride was reacted with stirring at 170-180° C. for 2 to 3 hours with 0.8 to 1.4 eq of a difunctional or trifunctional amino-terminated polyalkylene glycol. The reaction product is optionally reacted at 80-110° C. for 45-120 minutes with 1 to 2 times its mass of an epoxy resin and 0.01 to 0.2 wt. % of triphenyl phosphine.

General Production Method for the Adhesive

All the components were mixed at room temperature in a Dalton Versatile Mixer under vacuum or a Flack Tek Speed Mixer until homogeneous and then packaged in storage containers.

### Examples 1-12

The resins shown in Table 1 were produced in accordance with the general method for component (B).

TABLE 1

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| D-2000 | 2476 | 2476 | | | 2011 | 2011 | | | 2578 | | 615 | 600 |
| T-3000 | | | 1500 | 1500 | | | 999 | 999 | | 2560 | | |
| TMA | 438 | 438 | | | 386 | 386 | 199 | 199 | 248 | 252 | 80.5 | 39.2 |
| MA | | | 141 | 141 | | | | | 128 | 126 | 20.3 | 39.6 |
| DGEBA | | 2914 | | 1641 | | 2397 | | 1198 | 2954 | 2938 | 716 | 680 |

D-2000: JEFFAMINE D-2000 (Huntsman), difunctional amino-terminated polypropylene glycol, MW 2000
T-3000: JEFFAMINE XTJ-509 (Huntsman), trifunctional amino-terminated polypropylene glycol, MW 3000
TMA: Trimellitic anhydride
MA: Maleic anhydride
DGEBA: DGEBA resin, epoxy equivalent weight 189

### Examples C13-C14

The resins shown in Table 2 were produced in accordance with the general method for component (C).

TABLE 2

Example

| | C13 | C14 |
|---|---|---|
| D-2000 | 2011 | 2011 |
| TMA | 386 | 386 |
| DGEBA | | 2361 |

D-2000: JEFFAMINE D-2000 (Huntsman), difunctional amino-terminated polypropylene glycol, MW 2000
TMA: Trimellitic anhydride
DGEBA: DGEBA resin, epoxy equivalent weight 189

### Examples 15-30

Adhesive compositions according to the present invention were produced in accordance with the general production method for the adhesive. Table 3 summarizes the compositions.

TABLE 3

| | Example | | | | | | | |
|---|---|---|---|---|---|---|---|---|
| | 15 | 16 | 17 | 18 | 19 | 20 | 21 | 22 |
| Component (B) | 60.0 | 120.0 | | | | | | |
| from Example 1 | | | | | | | | |
| Component (B) | | | 120.0 | 240.0 | | | | |
| from Example 2 | | | | | | | | |
| Component (B) | | | | | | | | |
| from Example 3 | | | | | | | | |
| Component (B) | 120.0 | | 120.0 | | | | | 120.0 |
| from Example 4 | | | | | | | | |
| Component (B) | | | | | 120.0 | | | |
| from Example 5 | | | | | | | | |
| Component (B) | | | | | | | 240.0 | 120.0 |
| from Example 6 | | | | | | | | |
| Component (B) | | | | | | 120.0 | | |
| from Example 7 | | | | | | | | |
| Component (B) | | | | | | | | |
| from Example 8 | | | | | | | | |
| Component (B) | | | | | | | | |
| from Example 9 | | | | | | | | |
| Component (B) | | | | | | | | |
| from Example | | | | | | | | |
| 10 | | | | | | | | |
| Component (B) | | | | | | | | |
| from Example | | | | | | | | |
| 11 | | | | | | | | |
| Component (B) | | | | | | | | |
| from Example | | | | | | | | |
| 12 | | | | | | | | |
| Component (A) | 120.0 | 120.0 | 120.0 | 120.0 | 120.0 | 120.0 | 120.0 | 120.0 |
| DGEBA | 60.0 | 120.0 | | | 120.0 | 120.0 | | |
| DGEBF | 150.0 | 150.0 | 150.0 | 150.0 | 150.0 | 150.0 | 150.0 | 150.0 |
| Dicyandiamide | 40.2 | 40.2 | 40.2 | 40.2 | 40.2 | 40.2 | 40.2 | 40.2 |
| Fenuron | 1.8 | 1.8 | 1.8 | 1.8 | 1.8 | 1.8 | 1.8 | 1.8 |
| PCC | 24.0 | 24.0 | 24.0 | 24.0 | 24.0 | 24.0 | 24.0 | 24.0 |
| Silica | 24.0 | 24.0 | 24.0 | 24.0 | 24.0 | 24.0 | 24.0 | 24.0 |
| | Example | | | | | | | |
| | 23 | 24 | 25 | 26 | 27 | 28 | 29 | 30 |
| Component (B) | | | | | | | | |
| from Example 1 | | | | | | | | |
| Component (B) | | | | | | | | |
| from Example 2 | | | | | | | | |
| Component (B) | | | | | | | | |
| from Example 3 | | | | | | | | |
| Component (B) | 120.0 | | | | | 26.27 | | |
| from Example 4 | | | | | | | | |
| Component (B) | | | | | | | | |
| from Example 5 | | | | | | | | |
| Component (B) | | 120.0 | | | | 26.27 | | |
| from Example 6 | | | | | | | | |
| Component (B) | 60.0 | 60.0 | | | | | | |
| from Example 7 | | | | | | | | |
| Component (B) | | | | | | | | |
| from Example 8 | | | | | | | | |
| Component (B) | | | 64.0 | | 32.0 | | | |
| from Example 9 | | | | | | | | |
| Component (B) | | | | 64.0 | 32.0 | | | |
| from Example | | | | | | | | |
| 10 | | | | | | | | |
| Component (B) | | | | | | | 64.0 | |
| from Example | | | | | | | | |
| 11 | | | | | | | | |
| Component (B) | | | | | | | | 64.0 |
| from Example | | | | | | | | |
| 12 | | | | | | | | |
| Component (A) | 120.0 | 120.0 | 32.0 | 32.0 | 32.0 | 26.27 | 32.0 | 32.0 |
| DGEBA | 60.0 | 60.0 | | | | | | |
| DGEBF | 150.0 | 150.0 | 40.0 | 40.0 | 40.0 | 56.25 | 40.0 | 40.0 |
| Dicyandiamide | 40.2 | 40.2 | 10.72 | 10.72 | 10.72 | 11.63 | 10.72 | 10.72 |
| Fenuron | 1.8 | 1.8 | 0.48 | 0.48 | 0.48 | 0.52 | 0.48 | 0.48 |
| PCC | 24.0 | 24.0 | 6.40 | 6.40 | 6.40 | 6.36 | 6.40 | 6.40 |
| Silica | 24.0 | 24.0 | 6.40 | 6.40 | 6.40 | 6.36 | 6.40 | 6.40 |

DGEBA: DGEBA resin, epoxy equivalent weight 189
DGEBF: DGEBF resin, epoxy equivalent weight 170 (e.g. EPR 151, Bakelite)
PCC: Coated precipitated calcium carbonate (e.g., ULTRA PFLEX, Specialty Minerals, Inc.)
Silica: CABOSIL TS 720

### Examples C31 -C32

Comparative adhesive compositions according to the prior art were produced in accordance with the general production method for the adhesive. Table 4 summarizes the compositions.

TABLE 4

Example

| | C31 | C32 |
|---|---|---|
| Component (C) | 120.0 | |
| from Example C13 | | |
| Component (C) | | 240.0 |
| from Example C14 | | |
| Component (A) | 120.0 | 120.0 |
| DGEBA | 120.0 | |
| DGEBF | 150.0 | 150.0 |
| Dicyandiamide | 40.2 | 40.2 |
| Fenuron | 1.8 | 1.8 |
| PCC | 24.0 | 24.0 |
| Silica | 24.0 | 24.0 |

DGEBA: DGEBA resin, epoxy equivalent weight 189
DGEBF: DGEBF resin, epoxy equivalent weight 170 (e.g. EPR 151, Bakelite)
PCC: Coated precipitated calcium carbonate (e.g. ULTRA PFLEX, Specialty Minerals, Inc.)
Silica: CABOSIL TS 720

The adhesive properties of the examples according to the present invention (Examples 15-30) and the adhesive properties of adhesives according to the prior art (Examples C31-C32) are compared in Table 5.

TABLE 5

| | Example | | | | | | | | |
|---|---|---|---|---|---|---|---|---|---|
| | 15 | 16 | 17 | 18 | 19 | 20 | 21 | 22 | 23 |
| TSS @ 23° C. (CRS) | 37.9 | 37.9 | 37.7 | 36.1 | 40.9 | 37.5 | 39.2 | 38.1 | 39.6 |
| [MPa] | | | | | | | | | |
| TSS @ 82° C. (CRS) | n.d. | n.d. | 22.3 | 20.9 | n.d. | n.d. | 22.9 | 25.3 | n.d. |
| [MPa] | | | | | | | | | |
| Peel (EZG) [N/mm] | 10.3 | 10.1 | 12.0 | 8.6 | 12.2 | 12.7 | 11.7 | 10.2 | 12.9 |
| Impact peel [N/mm] | 42.3 | 31.0 | 47.7 | 37.7 | 27.0 | 33.0 | 33.8 | 49.2 | n.d. |
| | Example | | | | | | | | |
| | 24 | 25 | 26 | 27 | 28 | 29 | 30 | C31 | C32 |
| TSS @ 23° C. (CRS) | 38.9 | 33.0 | 29.5 | 33.2 | 41.6 | 30.5 | 28.2 | 32.1 | 30.6 |
| [MPa] | | | | | | | | | |
| TSS @ 82° C. (CRS) | n.d. | n.d. | n.d. | n.d. | n.d. | n.d. | n.d | n.d. | n.d. |
| [MPa] | | | | | | | | | |
| Peel (EZG) [N/mm] | 13.2 | 10.9 | 9.8 | 10.2 | 13.1 | 7.8 | 8.7 | 6.6 | 5.2 |
| Impact peel [N/mm] | 33.3 | 41.8 | 37.2 | n.d. | n.d. | n.d. | 33.2 | 24.8 | 21.3 |

TSS: Tensile shear strength according to SAE J1523
Peel: T-Peel according ASTM D1876 at 23° C.
CRS: Cold rolled steel, 1.5 mm gauge
EZG: Electrogalvanized steel E60 EZG 60G
Impact peel: Impact wedge peel according to ISO 11343 at 2 m/s at 23° C. with 0.8 mm gauge cold rolled steel substrate

1. A curable composition comprising at least one polycarboxy-functionalized prepolymer having the structure R¹[—X—C(═O)-Cy(CO₂H)_{q}]ₙ[—X—C(═O)—R³—CO₂H]ₚ[X—H]ₘ₋₍ₙ₊ₚ₎, or at least one reaction product of said polycarboxy-functionalized prepolymer with at least one epoxy resin, or a mixture thereof, wherein R¹ is the m-valent radical of an elastomeric polymer, X is —O—, —S—, or —NR²—, Cy is an aromatic or aliphatic ring, R² is H or a C₁-C₆ alkyl group, R³ is a radical containing at least one carbon-carbon double bond, m is an integer from 2 to 6, n is an integer from 1 to 6, p is 0 or an integer from 1 to 5, m is greater than or equal to n+p, and q is an integer of at least 2.

2. A composition as claimed in claim 1 additionally comprising at least one polymer having at least one glass transition temperature of −30° C. or lower and epoxy-reactive groups, or at least one reaction product of said polymer with at least one epoxy resin, or a mixture thereof

3. A composition as claimed in claim 2 comprising at least one polymer based on 1,3-butadiene.

4. A composition as claimed in claim 2 comprising at least one polymer selected from the group consisting of carboxy-functionalized butadiene/acrylonitrile copolymers, butadiene/(meth)acrylic acid ester copolymers, carboxy-functionalized butadiene/acrylonitrile/styrene copolymers and butadiene/(meth)acrylate/styrene copolymers and epoxy resin adducts thereof.

5. A composition as claimed in claim 2 comprising at least one polymer selected from the group consisting of carboxy-functionalized butadiene/acrylonitrile copolymers and adducts of carboxy-functionalized butadiene/acrylonitrile copolymers and polyglycidyl ethers of bisphenols.

6. A composition as claimed in claim 1 wherein said at least one polycarboxy-functionalized prepolymer is produced by a reaction between:
(a) at least one carboxylic anhydride selected from the group consisting of 1,2,3-benzenetricarboxylic anhydride, 1,2,4-benzenetricarboxylic anhydride, monoesters of pyromellitic monoanhydride, monoamides of pyromellitic monoanhydride, 1,4,5-naphthalenetricarboxylic anhydride, 2,3,5-naphthalenetricarboxylic anhydride, 2,3,6-naphthalenetricarboxylic anhydride, pyromellitic mono- and dianhydride, 1,8:4,5- and 2,3:6,7-naphthalenetetracarboxylic mono- and dianhydride, perylenetetracarboxyliic mono- and dianhydride, biphenyltetracarboxylic mono- and dianhydride, diphenyl ether tetracarboxylic mono- and dianhydride, diphenylmethanetetracarboxylic mono- and dianhydride, 2,2-diphenylpropanetetracarboxylic mono- and dianhydride, benzophenonetetracarboxylic mono- and dianhydride, and diphenyl sulfone tetracarboxylic mono- and dianhydride; and
(b) at least one polyamine selected from the group consisting of polyalkylene glycol diamines and triamines, and polybutadiene diamines and triamines;
under conditions effective to avoid imide formation.

7. A composition as claimed in claim 6 wherein said at least one polycarboxy-functionalized prepolymer is produced by a reaction between said at least one carboxylic anhydride, said at least one polyamine, and an unsaturated carboxylic anhydride selected from the group consisting of maleic anhydride, citraconic anhydride, itaconic anhydride, phenyl maleic anhydride, and dimethyl maleic anhydride.

8. A composition as claimed in claim 1 wherein X is —NH—.

9. A composition as claimed in claim 1 wherein m is 2 or 3.

10. A composition as claimed in claim 1 wherein said elastomeric polymer is selected from the group consisting of polyalkylene ethers and polybutadienes.

11. A composition as claimed in claim 1 additionally comprising at least one thermally activatable latent hardener selected from the group consisting of dicyandiamide, guanamines, guanidines, aminoguanidines, and aromatic diamines.

12. A composition as claimed in claim 1 additionally comprising at least one thermally activatable latent hardener.

13. A composition as claimed in claim 1 wherein p is 0.

14. A composition as claimed in claim 1 wherein p is 1 or 2, n is 1 or 2 and m is 2 or 3.

15. A composition as claimed in claim 1 comprising (a) 5 to 60 weight percent of at least one polymer having at least one glass transition temperature of −30° C. or lower and epoxy-reactive groups, or at least one reaction product of said polymer with at least one epoxy resin, or a mixture thereof, (b) 5 to 40 weight percent of said at least one polycarboxy-functionalized prepolymer or at least one reaction product of said polycarboxy-functionalized prepolymer with at least one epoxy resin, or a mixture thereof, and (c) 1 to 10 weight percent of at least one latent hardener.

16. A composition as claimed in claim 1 comprising an adduct of (i) a diglycidyl ether of bisphenol A, bisphenol F, or both bisphenol A and bisphenol F and (ii) the product of a reaction between:
(a) at least one carboxylic anhydride selected from the group consisting of 1,2,3-benzenetricarboxylic anhydride, 1,2,4-benzenetricarboxylic anhydride, monoesters of pyromellitic monoanhydride, monoamides of pyromellitic monoanhydride, 1,4,5-naphthalenetricarboxylic anhydride, 2,3,5-naphthalenetricarboxylic anhydride, 2,3,6-naphthalenetricarboxylic anhydride, pyromellitic mono- and dianhydride, 1,8:4,5- and 2,3:6,7-naphthalenetetracarboxylic mono- and dianhydride, perylenetetracarboxylic mono- and dianhydride, biphenyltetracarboxylic mono- and dianhydride, diphenyl ether tetracarboxylic mono- and dianhydride, diphenylmethanetetracarboxylic mono- and dianhydride, 2,2-diphenylpropanetetracarboxylic mono- and dianhydride, benzophenonetetracarboxylic mono- and dianhydride, and diphenyl sulfone tetracarboxylic mono- and dianhydride; and
(b) at least one polyamine selected from the group consisting of polyalkylene glycol diamines and triamines, and polybutadiene diamines and triamines;
under conditions effective to avoid imide formation.

17. A composition as claimed in claim 1 comprising an adduct of (i) a diglycidyl ether of bisphenol A, bisphenol F, or both bisphenol A and bisphenol F and (ii) the product of a reaction between:
(a) at least one carboxylic anhydride selected from the group consisting of 1,2,3-benzenetricarboxylic anhydride, 1,2,4-benzenetricarboxylic anhydride, monoesters of pyromellitic monoanhydride, monoamides of pyromellitic monoanhydride, 1,4,5-naphthalenetricarboxylic anhydride, 2,3,5-naphthalenetricarboxylic anhydride, 2,3,6-naphthalenetricarboxylic anhydride, pyromellitic mono- and dianhydride, 1,8:4,5- and 2,3:6,7-naphthalenetetracarboxylic mono- and dianhydride, perylenetetracarboxylic mono- and dianhydride, biphenyltetracarboxylic mono- and dianhydride, diphenyl ether tetracarboxylic mono- and dianhydride, diphenylmethanetetracarboxylic mono- and dianhydride, 2,2-diphenylpropanetetracarboxylic mono- and dianhydride, benzophenonetetracarboxylic mono- and dianhydride, and diphenyl sulfone tetracarboxylic mono- and dianhydride;
(b) at least one unsaturated carboxylic anhydride selected from the group consisting of maleic anhydride, citraconic anhydride, itaconic anhydride, phenyl maleic anhydride, and dimethyl maleic anhydride; and
(c) at least one polyamine selected from the group consisting of polyalkylene glycol diamines and triamines, and polybutadiene diamines and triamines;
under conditions effective to avoid imide formation.

18. A composition as claimed in claim 1 wherein said polycarboxy-functionalized prepolymer does not contain imide groups.

19. A composition as claimed in claim 1 wherein q is 2 or 3.

20. A composition as claimed in claim 1 wherein X is —NH—, q is 2, and m is 2 or 3.

21. A composition as claimed in claim 1 wherein Cy is selected from the group consisting of single aromatic rings, fused aromatic rings, and connected aromatic rings.

22. A composition as claimed in claim 1 wherein at least one —CO₂H group attached to Cy is separated by two carbon atoms from the —C(═O)— group also attached to Cy.

23. A composition as claimed in claim 1 additionally comprising at least one hyperbranched polymer containing polyester units.

24. A thermoset composition produced by heating a curable composition as claimed in claim 1.

25. A process for adhesively bonding a first material surface to a second material surface, comprising the following process steps:
(a) applying a layer of the curable composition as claimed in claim 1 to at least one of the first material surface and second material surfaces;
(b) joining the first material surface and the second material surface, with said layer of the curable composition between the first material surface and the second material surface; and
(c) curing the layer of curable composition by heating.

26. A process as claimed in claim 25 wherein at least one of said material surface and said second material surface is comprised of metal.

27. A process as claimed in claim 25 wherein said curable composition is additionally comprised of at least one thermally activatable latent hardener.

28. A process as claimed in claim 25 wherein said layer of said curable composition is pregelled prior to step (c).

29. A process as claimed in claim 25 wherein said layer of said curable composition is heated to a temperature of from 80 degrees C. to 210 degrees C. during step (c).
